(19) United States
(12) Patent Application Publication
(10) Pub. No.: US 2025/0260199 A1
(43) Pub. Date: Aug. 14, 2025

(54) CONFIGURABLE INTERFACE FOR MODULAR ELECTRONIC COMPONENTS

(71) Applicant: BAE Systems Information and Electronic Systems Integration Inc., Nashua, NH (US)

(72) Inventors: Jack T. Nigro, Nashua, NH (US); Katie T. Hugh, Brookline, NH (US); Mark L. Hummel, Peterborough, NH (US)

(73) Assignee: BAE Systems Information and Electronic Systems Integration Inc, Nashua, NH (US)

(21) Appl. No.: 18/439,352

(22) Filed: Feb. 12, 2024

(51) Int. Cl. H01R 13/645; H01R 13/518; H01R 43/18

(52) U.S. Cl. CPC H01R 13/6456; H01R 13/518; H01R 43/18

(57) ABSTRACT

A configurable interface for an electronic component includes a keying insert and an interface plate. The keying insert is configured to provide multiple keying options. The interface plate has an opening for receiving the keying insert. The interface may further include additional features, such as guidance for blind mate scenarios, any of a basket, a busing having a recess, and a retention cover. In one example, the retention cover has a tab configured to extend into the recess of the bushing to secure one end of the retention cover to the bushing. The keying insert can include a keyway offset from an axis passing through a center of the keying insert. The retention cover is configured, while secured to the interface plate, to secure the basket in one opening of the interface plate and to secure the keying insert in another opening of the interface plate.

### FIELD OF DISCLOSURE

The present disclosure relates to a modular electronic components, and more particularly, to a configurable interface for electronic components.

### BACKGROUND

Certain electronic components are assembled as units or modules having electrical and/or optical interfaces, and mechanical interfaces for connecting several components together. For example, several components can be attached to a backplane or other connection point via the electrical interfaces to facilitate inter-component communications and/or to supply electrical power to the components. Such interfaces permit components having compatible connectors to be interchangeably connected as modules of a larger circuit, device, or system. Connectors can have a wide range of designs to suit different applications and uses, which can increase the cost and complexity of the interfaces with respect to standardized implementations. Thus, there remain a number of non-trivial challenges with respect to designing and manufacturing modular interfaces for electronic components.

### BRIEF DESCRIPTION OF THE DRAWINGS

FIG. 1 is a perspective exploded view of part of a configurable interface for an electronic component, in accordance with an example of the present disclosure.

FIG. 2 is a perspective view of the interface of FIG. 1 in an assembled state, in accordance with an example of the present disclosure.

FIG. 3 is a perspective view of an interface plate of the interface of FIGS. 1 and 2, in accordance with an example of the present disclosure.

FIGS. 4A and 4B are perspective views of a basket and a retention cover of the interface of FIGS. 1 and 2, in accordance with an example of the present disclosure.

FIGS. 5A and 5B are perspective views of a bushing of the interface of FIGS. 1 and 2, in accordance with an example of the present disclosure.

FIG. 6 is a plan view of a backplane having one or more of the interfaces of FIGS. 1 and 2 in various configurations, in accordance with an example of the present disclosure.

FIG. 7 is a plan view of an interface backplane having the interface of FIGS. 1 and 2, in accordance with examples of the present disclosure.

FIGS. 8A, 8B, and 8C illustrate how various components of the interfaces of FIGS. 1-7 can be assembled, in accordance with an example of the present disclosure.

FIG. 9 is a perspective view of the interface of FIG. 1 with a cover attached, in accordance with an example of the present disclosure.

FIG. 10 is an elevational cross-section of the interface of FIG. 9 with the cover attached, in accordance with an example of the present disclosure.

FIG. 11 is a partial elevational cross-section of the interface of FIG. 1 showing an alignment feature, in accordance with an example of the present disclosure.

Although the following detailed description will proceed with reference being made to illustrative embodiments, many alternatives, modifications, and variations thereof will be apparent in light of this disclosure.

### DETAILED DESCRIPTION

A configurable interface for an electronic component is provided. In an example, the interface includes an or several openings for a connector, alignment holes, a keying insert and an interface plate having an opening for receiving the keying insert. The keying insert can be configured to provide a plurality of distinct keying options. In some cases, the configurable interface may include a basket, wherein the interface plate has another opening for receiving the basket. The interface may further include a bushing having a recess. In some cases, the interface includes a retention cover having a tab configured to extend into the recess of the bushing. In some cases, the basket includes a plurality of openings for receiving an electrical connection therethrough. In some cases, the keying insert can provide 2 to 4 distinct keying options, depending on its orientation within the opening of the interface plate. The configurable interface can include a first fastener configured to secure the bushing to a planar surface of the interface plate, and a second fastener configured to secure the retention cover to the planar surface of the interface plate. The keying insert can include, in some examples, a keyway offset from an axis passing through a center of the keying insert, wherein the keying insert further includes a lip that is substantially flush with the interface plate while the keying insert is received in the second opening. The retention cover can include, in some examples, a third opening corresponding to the first opening of the interface plate, and a fourth opening corresponding to the second opening of the interface plate. The retention cover is configured, while secured to the interface plate, to secure the basket in the first opening of the interface plate and to secure the keying insert in the second opening of the interface plate. Numerous other embodiments and variations of the device will be apparent.

### General Overview

As noted above, modular components can be electrically coupled via compatible connectors to provide power and/or signals between the components as well as mechanical alignment and proper mating and mounting for the modules to the backplane. A particular type of interface is called a blind mate interface. A blind mate interface facilitates alignment of the connector during mating. For example, a connector—sometimes referred to as a keyed connector—can include pins, cutouts, ears, or other features that restrict the connector to a single mating orientation. A blind mate interface includes additional features that help to align the connector in the correct orientation as it is mated to another, complementary connector, such as mounted on a backplane or a circuit board. Blind mate interfaces used in modular component applications can have a wide range of designs to suit different applications and uses, such that each interface is unique.

### Configurable Interface

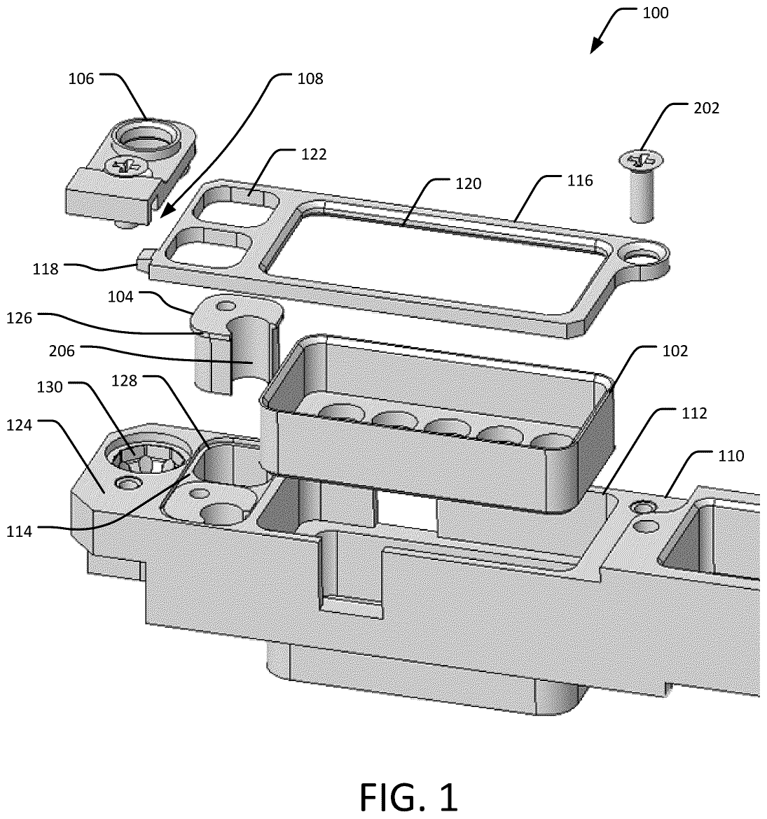

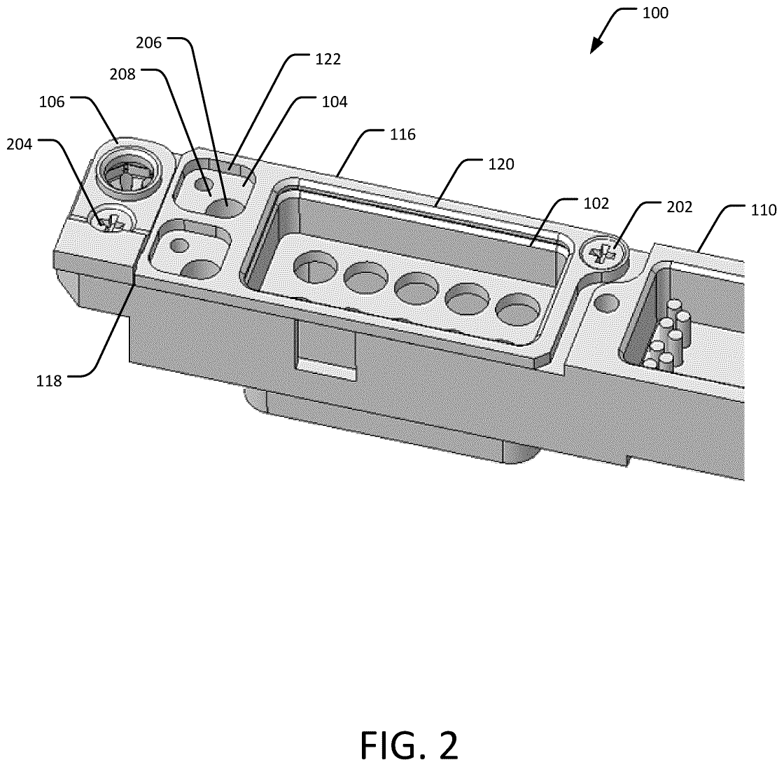

FIG. 1 is a perspective exploded view of a configurable interface 100 for an electronic component, in accordance with an example of the present disclosure. The interface 100 includes a basket 102, a keying insert 104, a bushing 106 having a recess 108, an interface plate 110, and a retention cover 116 having a tab 118 at one end that is configured to extend into, and be secured within, the recess 108 of the bushing 106. In some examples, the basket 102 may be omitted, such as for fiber optic connections or connectors with different form factors. The interface plate 110 includes a first opening 112 for receiving the basket 102 and a second opening 114 for receiving the keying insert 104. In some examples, the interface plate 110 includes at least two of the second openings 114 for receiving multiple keying inserts 104, such as shown in FIG. 1. The interface plate 110 further includes one or more planar surfaces 124 that are adjacent to the bushing 106 and the retention cover 116 while the interface 100 is at least partially assembled, such as shown in FIG. 2. The basket 102 includes multiple openings, also referred to as positions, for receiving an electrical connection therethrough. For example, the electrical connection can be a connector coupled to a cable having multiple electrical or optical conductors. The retention cover 116 includes a third opening 120 corresponding to the first opening 112 of the interface plate, and a fourth opening 122 corresponding to the second opening 114 of the interface plate 110.

The keying insert 104 includes a lip 126 that is substantially flush with the planar surface 124 of the interface plate 110 while the keying insert 104 is fully received or otherwise installed in the second opening 114 of the interface plate 110. When fully received in the second opening 114, the lip 126 abuts a shoulder 128 of the second opening 114, which limits the travel of the keying insert 104 within the second opening 114 and helps align the keying insert 104 with the keying insert opening 122 of the retention cover 116. In this example, the keying insert 104 may be oriented in opening 114 in one of four distinct orientations, so as to provide four distinct keying options. Where multiple keying inserts 104 are used, additional keying options are possible since each keying insert 104 can have, for example, four orientations.

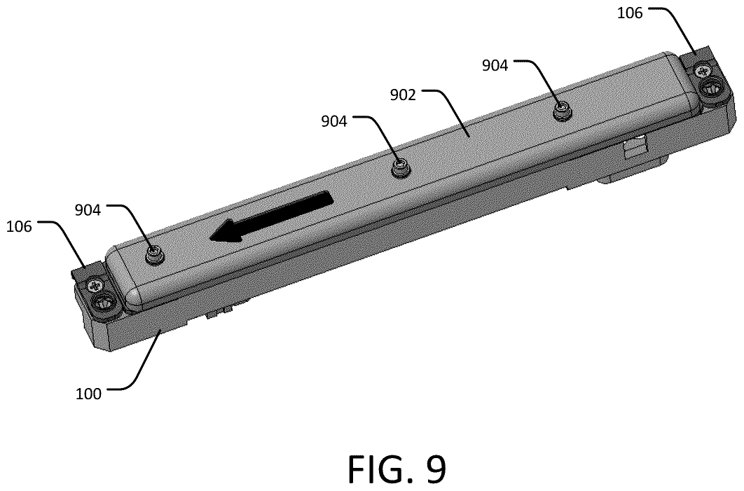

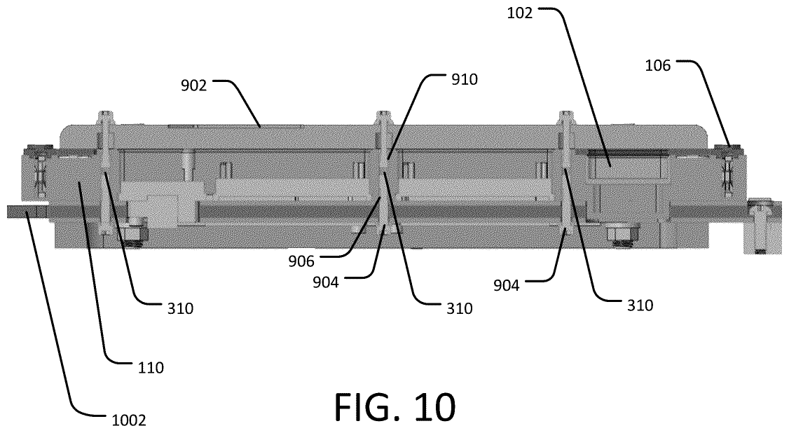

In some examples, the interface 100 includes an alignment spring 130 configured to receive an alignment pin of a cover plate via the bushing 106, such as described with respect to FIGS. 9-10.

FIG. 2 is a perspective view of the interface 100 in an assembled state, in accordance with an example of the present disclosure. The interface 100 includes a first fastener 202 configured to secure the retention cover 116 to the planar surface 124 of the interface plate 110, and a second fastener 204 configured to secure the bushing 106 to the planar surface 124 of the interface plate 110. In the assembled state, the tab 118 is inserted into, and captured within, the recess 108 of the bushing 106 to further secure the retention cover 116 to the interface plate 110. The retention cover 116 is configured, while secured to the interface plate 110, to secure the basket 102 in the first opening 112 of the interface plate and to secure the keying insert 104 in the second opening 114 of the interface plate 110.

The second opening 114 of the interface plate 110 can be dimensioned to provide a slip fit (little to no friction) or an interference (pressure or friction) fit for the keying insert 104. For example, the dimensions of the second opening 114 are such that the keying insert 104 is not permitted substantial lateral or rotational movement while received in the second opening 114.

The keying insert 104 includes a keyway 206, which is offset from an axis passing through a center 208 of the keying insert 104. The keyway 206 of the keying insert 104 is configured to receive a key or other structural member of a blind mate connector that is inserted into the interface 100. The key prevents the blind mate connector from mating with the interface 100 in an incorrect orientation or an incorrect configuration (to prevent damage to the interface and the connector when attempting to use the wrong connector).

As described above, the interface 100 is configurable to accommodate different keying configurations of the blind mate connector and/or different types of keyed connectors. For example, the keying insert 104 can be rotated about the center 208 to lie in different positions or quadrants of the second opening 114 of the interface plate 110, so as to provide four distinct keying options. Other examples may have fewer options or just one, while still other examples may have more options. In another example, the keyway 206 of the keying insert 104 can have different shapes, sizes, and/or positions to accommodate various types of connectors, or a blocking insert. As noted above, in some examples, multiple keying inserts 104 can be employed, with each keying insert 104 capable of being inserted into a corresponding one of the second openings 114 of the interface plate 110 to provide various keying combinations, such as shown in FIG. 2. In yet another example, the size of the first opening 112 and the second opening 114 of the interface plate 110, and the corresponding third opening 120 and fourth opening 122 of the retention cover 116, can be modified to accommodate various types of connectors.

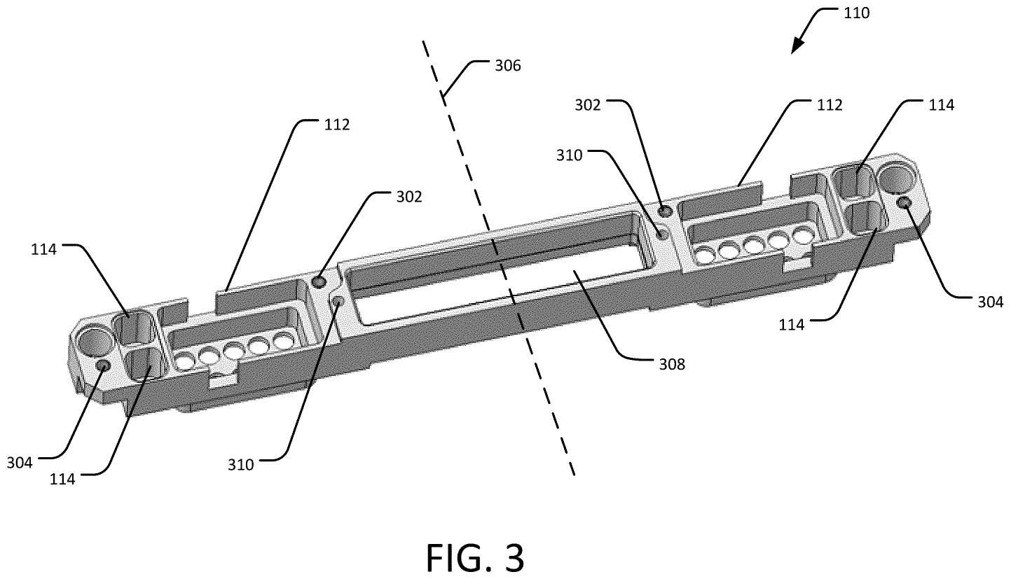

FIG. 3 is a perspective view of the interface plate 110 of FIGS. 1 and 2, in accordance with an example of the present disclosure. The interface plate 110 includes a first bore 302 for receiving the first fastener 202 and a second bore 304 for receiving the second fastener 204. The first bore 302 and/or the second bore 304 can be threaded to receive the first fastener 202 and the second fastener 204, respectively. In some examples, the structure of the interface plate 110 can be at least partially symmetric about an axis 306 passing through a midpoint of the interface plate 110, such as shown in FIG. 3. In such a configuration, the interface plate 110 includes two first openings 112 and at least two second openings 114. The interface plate 110 can, in some examples, include additional features, such as a connector insert opening 308 between the first openings 112 for receiving an additional connector (e.g., a blind mate or other keyed connector) therethrough.

In some examples, the interface plate 110 further includes one or more through-holes 310. The through-holes 310 are used on the underside of the interface plate 110 to attach the interface plate 110 to the backplane and on the topside (visible in FIG. 3) to attach a cover (see FIGS. 9-10) to the interface plate 110. Both sides of the hole can be threaded to receive a fastener.

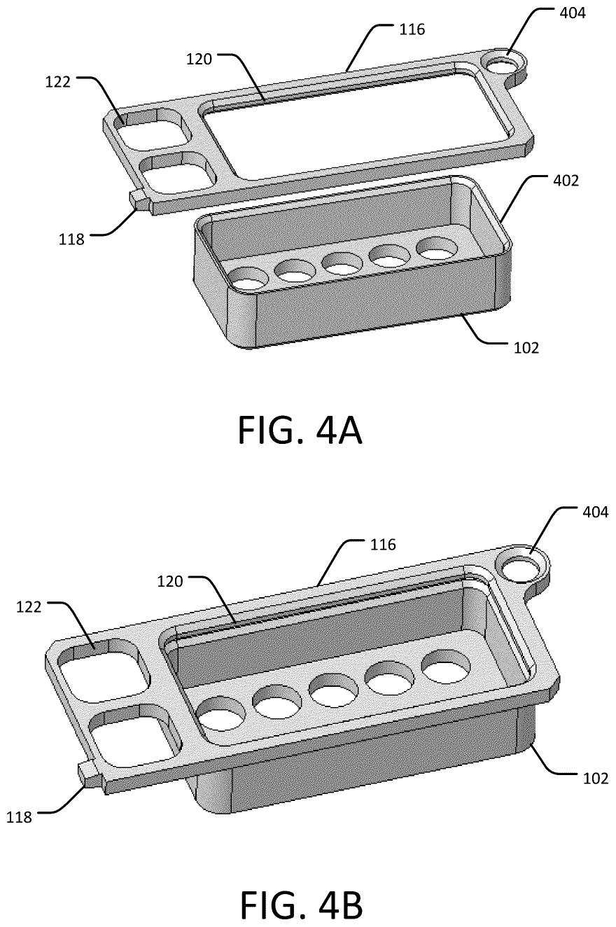

FIGS. 4A and 4B are perspective views of the basket 102 and the retention cover 116 of FIGS. 1 and 2, in accordance with an example of the present disclosure. In FIG. 4A the basket 102 and the retention cover 116 are shown separated. In FIG. 4B, the retention cover 116 is shown adjacent to the basket 102. The third opening 120 is smaller than, or the same size as, an upper edge 402 of the basket 102 so that the retention cover 116 secures the basket 102 in the interface plate 110. The retention cover 116 includes the tab 118 for securing the retention cover 116 to the bushing 106 and an opening 404 for receiving the first fastener 202 therethrough.

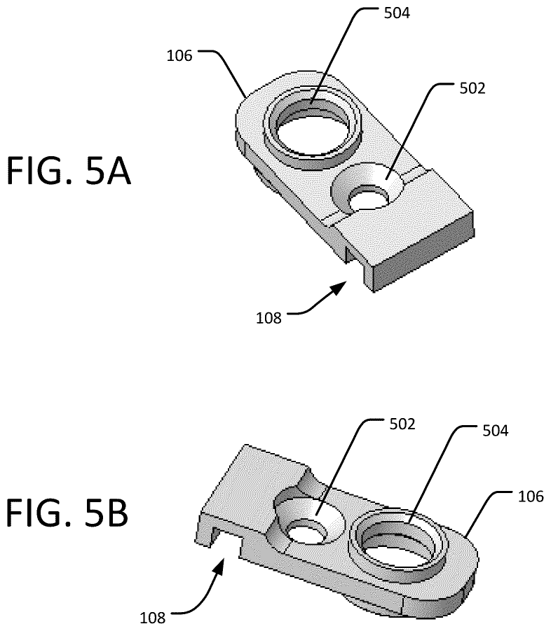

FIGS. 5A and 5B are perspective views of the bushing 106 of FIGS. 1 and 2, in accordance with an example of the present disclosure. The bushing 106 includes a first opening 502 for receiving the second fastener 204 therethrough. The recess 108 can include, for example, a notch, channel, or other opening that is sized to receive the tab 118 of the retention cover 116. The bushing 106 further includes a second opening 504 for guiding the mating interface.

### Interface Backplane

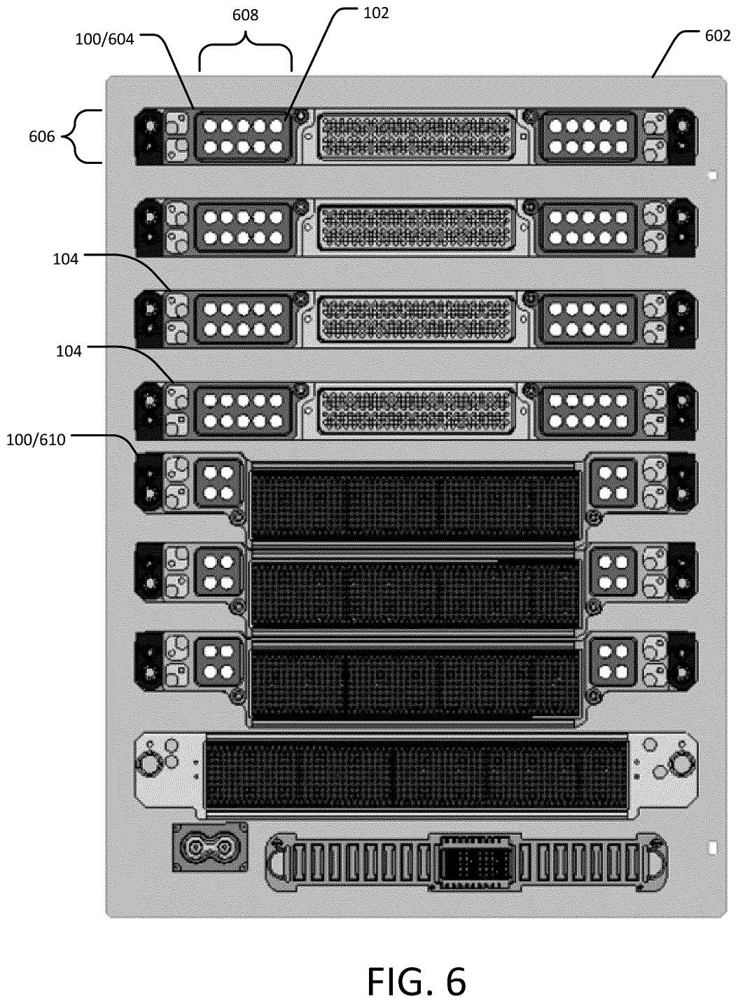

FIG. 6 is a view of an interface assembly including a backplane 602, in accordance with an example of the present disclosure. The backplane 602 includes one or more interfaces 100, such as described with respect to FIGS. 1-5. Each interface 100 can be configured to accommodate different sizes and shapes of connectors. For example, as shown in FIG. 6, the basket 102 of a first interface 604 has a height 606 of two unit lengths and a width 608 of five unit lengths. In this context, one unit length represents a dimension that accommodates one connector pin within the basket 102. In another example, the basket 102 of a second interface 610 has a height 606 of two unit lengths and a width 608 of two unit lengths.

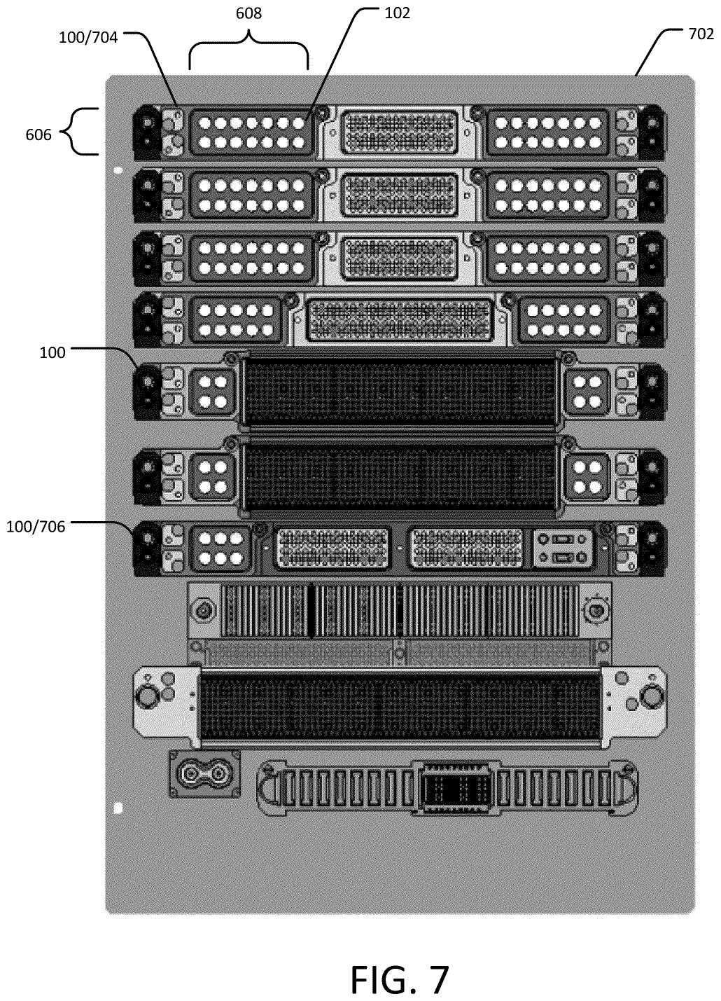

FIG. 7 is a view of an interface assembly including a backplane 702, in accordance with an example of the present disclosure. The backplane 702 includes one or more interfaces 100, such as described with respect to FIGS. 1-5. Similar to the backplane 602 of FIG. 6, each interface 100 can be configured to accommodate different sizes, shapes, and types of connectors, such as digital connectors, radio frequency (RF) connectors, and fiber optic connectors. For example, as shown in FIG. 7, the basket 102 of a third interface 704 has a height 606 of two unit lengths and a width 608 of seven unit lengths. In another example, the basket 102 of a fourth interface 706 has a height 606 of two unit lengths and a width 608 of three unit lengths.

In some other examples, the basket 102 of the interface 100 has a height of one unit length, two unit lengths, three unit lengths, four unit lengths, etc., and a width of one unit length, two unit lengths, three unit lengths, four unit lengths, five unit lengths, six unit lengths, seven unit lengths, etc.

### Interface Assembly

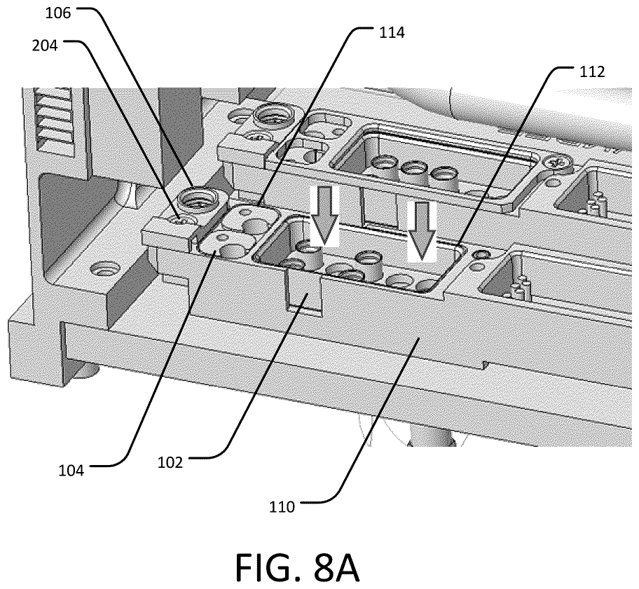

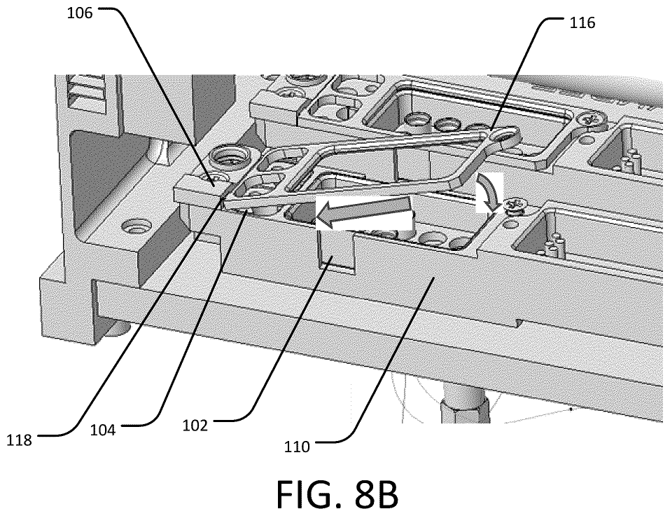

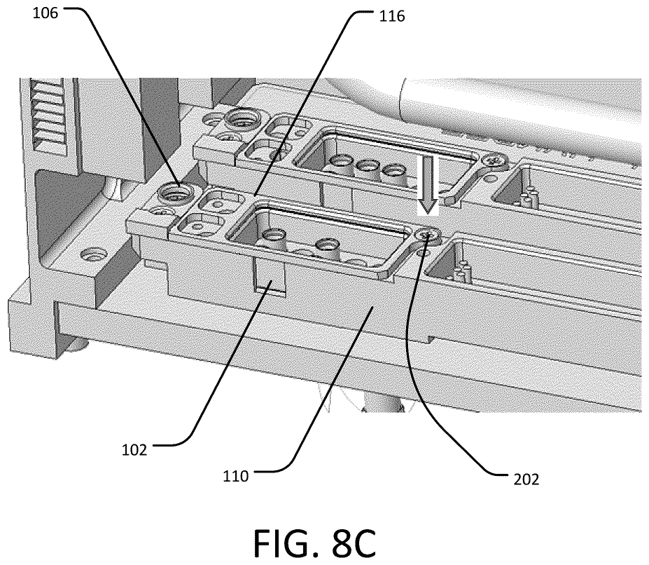

FIGS. 8A, 8B, and 8C illustrate how various components of the interface 100 of FIGS. 1-7 can be assembled, in accordance with an example of the present disclosure. In FIG. 8A, the basket 102 is inserted into the first opening 112 of the interface plate 110, and one or more keying inserts 104 are inserted into the second opening(s) 114 of the interface plate 110. The bushing 106 is attached to the interface plate 110 using the second fastener 204.

As noted above with respect to FIG. 2, the interface 100 is configurable to accommodate different keying configurations of the blind mate connector and/or different types of keyed connectors. For example, the keying insert 104 can be rotated to lie in different positions or quadrants of the second opening 114 of the interface plate 110. In another example, the keyway 206 of the keying insert 104 can have different shapes, sizes, and/or positions to accommodate various types of connectors. In some examples, multiple keying inserts 104 can be employed, with each keying insert 104 capable of being inserted into a corresponding one of the second openings 114 of the interface plate 110 to provide various keying combinations, such as shown in FIGS. 6, 7, and 8A-C.

In FIG. 8B, the tab 118 of the retention cover 116 is inserted into the recess 108 of the bushing 106. The retention cover 116 is then rotated downwards and fastened to the interface plate 110 using the first fastener 202, as shown in FIG. 8C, thereby securing the basket 102 and the keying insert(s) 104 to the interface plate 110.

As noted above, module interface plates are typically long lead items and have tight tolerances. Examples of the present disclosure include interface plates having a common housing design that promotes economies of scale across multiple modules and multiple applications that utilize such modules. For example, when a package has volume constraints within the chassis (such as module cover-to-cover width), the disclosed interface plates can be customized to increase module density and promote reuse across various designs. Furthermore, configurable keying allows the same housing part number to be used on different modules with the same form factor but still prevent a module from being installed in the wrong position or orientation.

### Interface Plate Cover

FIG. 9 is a perspective view of the interface 100 of FIG. 1 with a cover 902 attached and FIG. 10 is an elevational cross-section of the interface 100 with the cover 902 attached, in accordance with an example of the present disclosure. One or more fasteners 904 (e.g., threaded fasteners) can be used to attach the cover 902 to the interface 100 via the through-holes 310, the first bore 302, and/or the second bore 304 of the interface plate 110, such as shown in FIG. 3.

The cover 902 can be used in place of a module to protect the connector from foreign object damage or environmental damage such as dust. As shown in FIG. 10, the fasteners 904 come up through the bottom of a printed circuit board (PCB) 1002 and engage with helical inserts 906 at the bottom of the interface plate 110. Another set of helical inserts 910 in the through-holes 310 at the top of the interface plate can be used to attach the cover 902.

### Alignment Feature

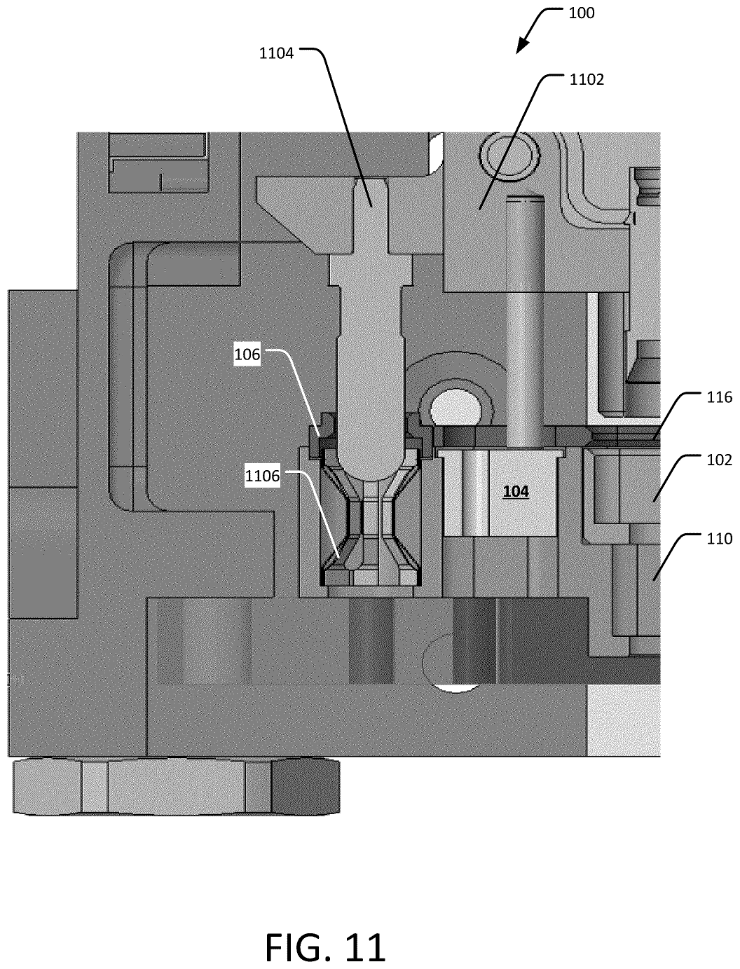

FIG. 11 is a partial elevational cross-section of the interface 100 of FIG. 1 showing an alignment feature, in accordance with an example of the present disclosure. FIG. 11 shows a portion of a connector 1102, an alignment pin 1104, and a ground spring 1106. The alignment pin 1104 is configured to align the connector 1102 with the bushing 106 of the interface 100 and to engage with the ground spring 1106. The ground spring 1106 is held in place by the bushing 106.

### Further Example Embodiments

The following examples pertain to further embodiments, from which numerous permutations and configurations will be apparent.
Example 1 provides a configurable interface for an electronic component, comprising a keying insert configured to provide a plurality of distinct keying options; and an interface plate having an opening for receiving the keying insert.
Example 2 includes the subject matter of Example 1, wherein the opening is a first opening, the configurable interface further comprising a basket, wherein the interface plate has a second opening for receiving the basket.
Example 3 includes the subject matter of Example 2, further comprising a bushing having a recess.
Example 4 includes the subject matter of Example 3, further comprising a retention cover having a tab configured to extend into the recess of the bushing.
Example 5 includes the subject matter of Example 4, further comprising a first fastener configured to secure the bushing to a planar surface of the interface plate, and a second fastener configured to secure the retention cover to the planar surface of the interface plate.
Example 6 includes the subject matter of any one of Examples 4 and 5, wherein the retention cover includes a third opening corresponding to the first opening of the interface plate, and a fourth opening corresponding to the second opening of the interface plate.
Example 7 includes the subject matter of Example 6, wherein the retention cover is configured, while secured to the interface plate, to secure the basket in the second opening of the interface plate and to secure the keying insert in the first opening of the interface plate.
Example 8 includes the subject matter of any one of Examples 2-7, wherein the basket includes a plurality of openings for receiving an electrical connection therethrough.
Example 9 includes the subject matter of Example 8, wherein the basket has a height of one or more unit lengths and a width of one or more unit lengths.
Example 10 includes the subject matter of any one of Examples 1-9, wherein the keying insert includes a keyway offset from an axis passing through a center of the keying insert, and wherein the keying insert further includes a lip that is substantially flush with the interface plate while the keying insert is received in the opening.
Example 11 includes the subject matter of any one of Examples 1-10, wherein the keying insert can provide two or more distinct keying options, depending on an orientation of the keying insert within the opening.
Example 12 provides a method of assembling a configurable interface for an electronic component, the method comprising inserting a keying insert into an opening of the interface plate; attaching a bushing having a recess to the interface plate; and inserting a tab of a retention cover into the recess of the bushing.
Example 13 includes the subject matter of Example 12, further comprising securing the bushing to a planar surface of the interface plate using a first fastener, and securing the retention cover to the planar surface of the interface plate using a second fastener; and/or securing the keying insert in the opening of the interface plate while the retention cover is secured to the interface plate.
Example 14 includes the subject matter of any one of Examples 12 and 13, wherein the keying insert includes a keyway offset from an axis passing through a center of the keying insert, and wherein the keying insert further includes a lip that is substantially flush with the interface plate while the keying insert is received in the opening; the retention cover includes a third opening corresponding to the opening of the interface plate.
Example 15 provides a configurable interface, comprising a basket; a keying insert; a bushing having a recess; an interface plate having a first opening for receiving the basket and a second opening for receiving the keying insert; and a retention cover having a tab configured to extend into the recess of the bushing.
Example 16 includes the subject matter of Example 15, further comprising a first fastener configured to secure the bushing to a planar surface of the interface plate, and a second fastener configured to secure the retention cover to the planar surface of the interface plate.
Example 17 includes the subject matter of any one of Examples 15 and 16, wherein the keying insert includes a keyway offset from an axis passing through a center of the keying insert, and wherein the keying insert further includes a lip that is substantially flush with the interface plate while the keying insert is received in the second opening.
Example 18 includes the subject matter of any one of Examples 15-17, wherein the retention cover includes a third opening corresponding to the first opening of the interface plate, and a fourth opening corresponding to the second opening of the interface plate, and wherein the retention cover is configured, while secured to the interface plate, to secure the basket in the first opening of the interface plate and to secure the keying insert in the second opening of the interface plate.
Example 19 includes the subject matter of any one of Examples 15-19, wherein the basket includes a plurality of openings for receiving an electrical connection therethrough, and wherein the basket has a height of two unit lengths and a width of one of: one unit length, two unit lengths, three unit lengths, four unit lengths, five unit lengths, six unit lengths, and seven unit lengths.
Example 20 provides a system comprising a backplane and one or more of the configurable interface of any one of Examples 15-19, each of the one or more of the configurable interface being attached to the backplane.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A configurable interface for an electronic component, comprising:
a keying insert configured to provide a plurality of distinct keying options, the keying insert including a keyway offset from an axis passing through a center of the keying insert; and
an interface plate having an opening for receiving the keying insert.

2. The configurable interface of claim 1, wherein the opening is a first opening, the configurable interface further comprising a basket, wherein the interface plate has a second opening for receiving the basket.

3. The configurable interface of claim 2, further comprising a bushing having a recess.

4. The configurable interface of claim 3, further comprising a retention cover having a tab configured to extend into the recess of the bushing.

5. The configurable interface of claim 4, further comprising a first fastener configured to secure the bushing to a planar surface of the interface plate, and a second fastener configured to secure the retention cover to the planar surface of the interface plate.

6. The configurable interface of claim 4, wherein the retention cover includes a third opening corresponding to the first opening of the interface plate, and a fourth opening corresponding to the second opening of the interface plate.

7. The configurable interface of claim 6, wherein the retention cover is configured, while secured to the interface plate, to secure the basket in the second opening of the interface plate and to secure the keying insert in the first opening of the interface plate.

8. The configurable interface of claim 2, wherein the basket includes a plurality of openings for receiving an electrical connection therethrough.

9. The configurable interface of claim 8, wherein the basket has a height of one or more unit lengths and a width of one or more unit lengths.

10. The configurable interface of claim 1, wherein the keying insert further includes a lip that is substantially flush with the interface plate while the keying insert is received in the opening.

11. The configurable interface of claim 1, wherein the keying insert can provide two or more distinct keying options, depending on an orientation of the keying insert within the opening.

12. A method of assembling a configurable interface for an electronic component, the method comprising:
inserting a keying insert into an opening of an interface plate, the keying insert including a keyway offset from an axis passing through a center of the keying insert;
attaching a bushing having a recess to the interface plate; and
inserting a tab of a retention cover into the recess of the bushing.

13. The method of claim 12, further comprising:
securing the bushing to a planar surface of the interface plate using a first fastener, and securing the retention cover to the planar surface of the interface plate using a second fastener; and/or
securing the keying insert in the opening of the interface plate while the retention cover is secured to the interface plate.

14. The method of claim 12, wherein:
the keying insert further includes a lip that is substantially flush with the interface plate while the keying insert is received in the opening; and
the retention cover includes a third opening corresponding to the opening of the interface plate.

15. A configurable interface, comprising:
a basket;
a keying insert including a keyway offset from an axis passing through a center of the keying insert;
a bushing having a recess;
an interface plate having a first opening for receiving the basket and a second opening for receiving the keying insert; and
a retention cover having a tab configured to extend into the recess of the bushing.

16. The configurable interface of claim 15, further comprising a first fastener configured to secure the bushing to a planar surface of the interface plate, and a second fastener configured to secure the retention cover to the planar surface of the interface plate.

17. The configurable interface of claim 15, wherein the keying insert includes a keyway offset from an axis passing through a center of the keying insert, and wherein the keying insert further includes a lip that is substantially flush with the interface plate while the keying insert is received in the second opening.

18. The configurable interface of claim 15, wherein the retention cover includes a third opening corresponding to the first opening of the interface plate, and a fourth opening corresponding to the second opening of the interface plate, and wherein the retention cover is configured, while secured to the interface plate, to secure the basket in the first opening of the interface plate and to secure the keying insert in the second opening of the interface plate.

19. The configurable interface of claim 15, wherein the basket includes a plurality of openings for receiving an electrical connection therethrough, and wherein the basket has a height of two unit lengths and a width of one of: one unit length, two unit lengths, three unit lengths, four unit lengths, five unit lengths, six unit lengths, and seven unit lengths.

20. A system comprising a backplane and one or more of the configurable interface of claim 15, each of the one or more of the configurable interface being attached to the backplane.
